(19) United States
(12) Patent Application Publication
(10) Pub. No.: US 2026/0357379 A1
(43) Pub. Date: Nov. 12, 2026

(54) LEACHING PROCESS

(71) Applicant: BHP INNOVATION PTY LTD, Melbourne, Victoria (AU)

(72) Inventors: Michael J. Nicol, Melbourne, Victoria (AU); Xiangfei Ye, Melbourne, Victoria (AU); Stephen Liddell, Melbourne, Victoria (AU); Neil Garrard, Melbourne, Victoria (AU)

(73) Assignee: BHP INNOVATION PTY LTD, Melbourne, Victoria (AU)

(21) Appl. No.: 19/469,874

(22) PCT Filed: Mar. 28, 2024
(86) PCT No.: PCT/AU2024/050288

§ 371 Date: Sep. 26, 2025

(30) Foreign Application Priority Data
Mar. 29, 2023 (AU) 2023900875

(51) Int. Cl. C22B 60/02; C22B 3/10; C22B 11/00; C22B 15/00

(52) U.S. Cl. CPC C22B 60/023; C22B 3/10; C22B 11/04; C22B 15/0069

(57) ABSTRACT

The present invention is directed to the use of a combination of chlorate and chlorine in an acidic solution to enhance the rate of dissolution of a target metal from an ore material during leaching. In one aspect, the present invention provides a process for recovering one or more target metals from an ore material, comprising: treating the ore material with a leaching solution, said leaching solution being an aqueous, acidic, saline solution containing chlorate, to produce a pregnant leach solution of the target metal(s); and recovering the target metal(s) from the pregnant leach solution.

### REFERENCE TO EARLIER APPLICATION

The present application claims priority from Australian Provisional Patent Application No. 2023900875, the entire contents of which is incorporated herein by reference.

### TECHNICAL FIELD

The present disclosure relates to a method for recovery of a target metal from an ore material. The method may be used for leaching of copper from copper ore or a concentrate, particularly from refractory sulphide minerals such as chalcopyrite (Cpy). The method may additionally or instead be used for leaching precious metals, such as gold and/or silver. These applications are however exemplary only and are non-limiting because the principles of the disclosed method may be used for the recovery of other target metals, such as uranium, nickel, cobalt and the platinum group elements, from ore materials or concentrates.

### BACKGROUND ART

Copper occurs in nature primarily in the form of sulphide ore minerals. Common copper sulphide minerals include chalcocite (Cu₂S), bornite (Cu₅FeS₄), chalcopyrite (CuFeS₂), covellite (CuS), and digenite (Cu₉S). Chalcopyrite is the most abundant copper ore mineral but is, however, notoriously refractory and recovery of copper therefrom is problematic.

There have been numerous hydrometallurgical and pyrometallurgical processes proposed to recover copper from chalcopyrite. Hydrometallurgical processes have suffered from various disadvantages, including passivation of the mineral surface during the leaching process and low reaction rates. Pyrometallurgical processes also have drawbacks, such as high energy requirements and production of toxic by-products such as sulphur dioxide.

Research has previously been conducted on recovery of copper, uranium and precious metals (mainly gold and silver) from ore at Olympic Dam, Australia. The ore deposit at Olympic Dam contains copper principally in the form of sulphide minerals such as chalcocite (Cu₂S), bornite (Cu₅FeS₄) and chalcopyrite (CuFeS₂), and uranium principally in the form of such minerals as uraninite, coffinite and brannerite. The common gangue minerals may include quartz, hematite, feldspar, sericite, fluorite, siderite, chlorite and pyrite.

Research intended to support the eventual recovery of the metal values by a process including a heap leaching step has been undertaken. A conventional disadvantage of heap leaching is the relatively slow leach rates of ore minerals. In addition, the surfaces of some ore minerals, particularly copper sulphides such as chalcopyrite, can become passivated during the leaching step which can further reduce the leaching rate and lower the overall metal recovery.

Previous research work on the Olympic Dam ore has resulted in promising recoveries of uranium and copper under saline followed by hypersaline conditions using iron (III) and/or copper (II) as oxidants. However, the test results still highlight the problem of the rate of dissolution of copper sulphides (particularly chalcopyrite) being very low, for example requiring in excess of 600 days for reasonable recoveries (e.g., greater than 60%). Moreover, the heap leaching process does not recover precious metals in any appreciable quantities, meaning that alternative methods of precious metal recovery must be separately employed.

It would accordingly be desirable to provide an improved process for treating copper sulphide ore or concentrate, particularly a refractory mineral such as chalcopyrite, that overcomes, or at least reduces, the disadvantages and drawbacks of the prior art. It would also be desirable to provide an improved process for treating copper sulphide ore or concentrate that allows recovery of copper at enhanced rates. It would also be desirable to provide an improved heap leaching process for recovering copper from copper sulphide ore, particularly refractory minerals such as chalcopyrite, that enables the enhanced rate of recovery of copper. It would further be desirable to provide an improved process for the recovery of precious metals from an ore or concentrate material, particularly from an ore material comprising precious metals and copper sulphides. It would further be desirable to provide an improved process for the recovery of precious metals from an ore or concentrate material, particularly from an ore material comprising precious metals, uranium and copper sulphides. It would further be desirable to provide an improved process for multielement leaching of an ore material or concentrate that enabled the recovery of copper, uranium and precious metals in a single stage.

The above references to the background art do not constitute an admission that the art forms a part of the common general knowledge of a person of ordinary skill in the art. The above references are also not intended to limit the application of the process as disclosed herein.

### SUMMARY OF THE DISCLOSURE

The present invention is directed to the use of a combination of chlorate and chloride in an acidic solution to enhance the rate of dissolution of a target metal from an ore material during leaching. The combination of chlorate and chloride may, when provided as part of a leaching solution with a suitable redox potential, be advantageous for concomitantly leaching a base metal (e.g. copper and uranium) and one or more precious metals (and/or platinum group metals) from an ore material. Precious metals may include gold, silver, and/or platinum.

In a first aspect, the present invention provides a process for recovering a target metal from an ore material, comprising: treating the ore material with a leaching solution, said leaching solution having a redox potential greater than about 0.80 V and being an aqueous, acidic, chloride solution containing chlorate, to produce a pregnant leach solution of the target metal; and recovering the target metal from the pregnant leach solution. The target metal may be recovered from the pregnant leach solution using well-known techniques, such as solvent extraction and ion-exchange.

The leaching solution comprises acid, chlorate and chloride in sufficient concentrations to generate chlorine therein. Providing chlorate and chloride in sufficient concentrations to generate chlorine will result in a leaching solution with a redox potential greater than about 0.80V, often above 1.0 V.

The leaching solution may be formed in situ. In such embodiments, the process may comprise contacting the ore material with a leaching solution precursor. The leaching solution precursor may comprise some of the components of the leaching solution, with the remaining components being incorporated into the solution in situ due e.g. to dissolution of solids when contacted by the leaching solution precursor. The leaching solution precursor may be an aqueous solution containing chlorate.

In some embodiments, the ore material comprises a sulphide. The sulphide may comprise one or more of chalcocite, bornite and/or chalcopyrite. Embodiments of the invention may be well suited to leaching metals from chalcopyrite.

The process of this first aspect may be used for concomitantly leaching a base metal and one or more precious metals (and/or platinum group metals) from an ore material. Thus, the pregnant leach solution produced may comprise plural target metals, such as a base metal(s) and one or more precious metals (and/or platinum group metals). In some embodiments, the target metal comprises one or more of copper, uranium, gold and silver. Depending on the characteristics of the material being treated, the process may be applied to yield a pregnant leach solution comprising copper, uranium and gold.

In a second aspect, the present invention provides a process for recovering one or more target metals from an ore material, comprising: providing an ore material comprising reactive and refractory ore minerals; treating the ore material in a first stage with a first leaching solution, said first leaching solution being an aqueous, acidic, chlorate-free leaching solution, to leach at least some of the reactive ore minerals and producing a first pregnant leach solution containing one or more of said one or more target metals and a residue ore material that contains at least a major portion of said refractory ore minerals; treating the residue ore material in a second stage with a second leaching solution, said second leaching solution having a redox potential of greater than about 0.8 V and being an aqueous, acidic, chloride leaching solution containing chlorate, and producing a second pregnant leach solution containing said one or more target metals; and recovering the target metals from the first and second pregnant leach solutions. The target metals may be recovered from the first and second pregnant leach solution using well-known techniques, such as solvent extraction and ion-exchange.

It will be appreciated that the leaching solution used in the second stage may have the same characteristics as the leaching solution used in accordance with the first aspect described above and herein. Thus, as with the first aspect, the second leaching solution has a redox potential greater than about 0.80 V. In contrast the first leaching solution may have a lower redox potential than the second leaching solution. In particular, the first leaching solution may have a redox potential of as low as 0.7V.

The leaching solution may be formed in situ. In such embodiments, the process may comprise contacting the residue ore material with a leaching solution precursor. Prior to being contacted by the leaching solution precursor, the one or more additives may be added to the residue ore material, such as during an agglomeration process. The additives may dissolve when contacted by the leaching solution precursor to provide the second leaching solution. The leaching solution precursor may be an aqueous solution containing chlorate.

The process of this second aspect may be used for concomitantly leaching a base metal and one or more precious metals (and/or platinum group metals) from a refractory ore material. Thus, the process may be used for concomitantly leaching a base metal and one or more precious metals (and/or platinum group metals) from a residue ore material. In some embodiments, the target metal comprises one or more of copper, uranium, gold and silver. Depending on the characteristics of the reside ore being treated, the process may be applied to yield a pregnant leach solution comprising copper, uranium and gold.

As noted above, the residue includes a major portion of the refractory ore minerals from the initial ore material. These refractory ore minerals may comprise or include chalcopyrite.

In embodiments where the residue ore material comprises sulphide, by treating the residue ore material with the leaching solution, sulphur present as sulphide in the refractory ore minerals may be converted to elemental sulphur and/or sulphate.

The present invention also provides one or more target metals recovered from an ore material using a process in accordance with the present invention.

Also disclosed is a process for recovering target metals from an ore material, said target metals comprising a base metal and one or more precious metals (and/or platinum group metals), said process comprising: treating the ore material with a leaching solution, said leaching solution being an aqueous, acidic solution containing chloride and chlorate, to concomitantly leach the target metals to produce a pregnant leach solution of the target metals; and recovering the target metals from the pregnant leach solution. In this process the leaching solution may comprise acid, chlorate and chloride in sufficient concentrations to generate chlorine therein. As an alternative, in this process, sulphur present as sulphide in the ore material is converted to elemental sulphur and/or sulphate and the leaching solution can comprise acid, chlorate and chloride in sufficient concentrations to generate chlorine therein and, possibly, the leaching solution has a redox potential greater than 0.80V. As a further alternative, in this process, treatment of the ore material may be performed at temperature below 75 °C.

### DETAILED DESCRIPTION

The present invention relates to the use of chlorate and chloride in leaching solution (i.e. a solution comprising dissolved chloride) to enhance the rate of dissolution of a target metal from an ore material. For example, the addition of chlorate to a chloride leaching solution may enhance the rate of recovery of copper and/or precious metal from an ore material containing the copper and/or precious metal.

As used herein the term “chlorate” means the chlorate ion ClO₃— in aqueous solution. The chlorate ion may be derived from chloric acid (HClO₃) or any salt thereof, such as sodium chlorate NaClO₃. The chlorate may be formed in situ in solution or may be added thereto.

As used herein the term “chloride” means the chloride ion Cl⁻ in aqueous solution. The chloride salt may be an alkali metal chloride, alkaline earth metal chloride, ferric chloride or a mixture of two or more thereof. In embodiments, the leaching solution may be formed using one or more of sodium chloride, magnesium chloride and potassium chloride. Thus, sodium chloride, magnesium chloride and/or potassium chloride may be the primary source of the chloride in the leaching solution. Alternatively, or additionally, the leaching solution may be formed using seawater, brine prepared from rock salts, naturally occurring brines, or saline water obtained other sources, such as a recycled process stream or a salt-rich stream from a desalination plant. The leaching solution may be prepared using the intrinsic salts available from a water source.

As used herein “a heap” includes a heap, a dump, a vat or a column which contains an ore which is to be processed. While the present disclosure will focus on the application of the leaching process to a heap leach environment, it is to be understood that the process is not limited to that application.

The “leaching solution” (also referred to herein as “leach liquor”) is the solution that contacts the ore material and contains a lixiviant or more than one lixiviant to dissolve the target metal. It may be formed separately and applied to the ore material. Alternatively, it may be at least partially formed in situ. In the case of the ore material being treated in a heap of agglomerated ore, the leaching solution may be formed in situ from a combination of an applied irrigation solution, concentrated acid in the agglomerated ore and the in situ dissolution of any salt in the agglomerated ore.

The term “mixed potential” is the effective potential of the surface of an ore material in contact with an electrolyte (leaching solution) that is driving electrochemical corrosion.

The disclosure herein refers to “redox potential” or “potential” interchangeably. The redox potential (Eh) is a measure of the tendency of a solution or species to either gain or lose electrons and as used herein, is defined in reference to the standard hydrogen electrode (SHE).

The term “reactive ore minerals” means ore minerals that are not refractory and are therefore susceptible to being leached. Examples of reactive copper ore minerals include chalcocite, covellite and bornite. Examples of reactive uranium ore minerals include uraninite.

The term “refractory ore mineral” means an ore mineral that is resistant to leaching. Examples of refractory copper ore minerals include chalcopyrite and enargite. Examples of refractory uranium ore minerals include coffinite and brannerite.

Certain embodiments of the process disclosed herein may be applied to a wide variety of ore materials and grades. The ore material may be ore and/or an ore concentrate. The ore material may alternatively or in addition comprise a waste product or a by-product from a previous mineral processing operation. In an embodiment, the ore material is the product of a prior leaching operation, for example a heap leach ripios. The ore material may be tailings, such as flotation tailings.

In some embodiments, the ore material is a concentrate from a beneficiation process. During beneficiation, a concentrate is produced which has a higher grade of the target metal(s) compared to the run-of-mine ore material. For example, the grade of the concentrate material that is leached may be between about 20 wt. % to about 30 wt. %.

As above, in other embodiments, the ore material is the product of a prior leaching process. In these embodiments, the grade of the ore material to be leached may be as low as about 0.5 wt. %.

The ore material may be a refractory ore or derived from a refractory ore (e.g. ore concentrate or ripios). In some embodiments, the ore material may be a sulphide ore or derived from a sulphide ore. The ore material may be a refractory sulphide ore or derived therefrom. In some embodiments, the ore material comprises one or more base metal sulphides. The one or more base metal sulphides may comprise one or more sulphides of copper, zinc, cobalt, nickel and combinations thereof.

In some embodiments of the process, the ore material contains one or more copper sulphides. The copper sulphide(s) may be refractory. The copper sulphide(s) may include or comprise chalcopyrite. In some other embodiments of the process, the ore material contains one or more zinc, cobalt and/or nickel sulphides.

The ore material may comprise more than one target metal. The ore material may be a mixed ore material or derived from a mixture of ores.

In some embodiments, the ore material contains one or more precious metals. The one or more precious metals may be selected from gold and/or silver. Alternatively, or additionally, the ore material may contain uranium values, such as in the form of one or more uranium oxides. The one or more uranium oxides may include or comprise uraninite. The ore material may contain one or more base metals, uranium and/or one or more precious metals. Alternatively, or additionally, the ore material may contain one or more platinum group metals.

The ore material may contain one or more of copper, uranium and/or one or more precious metals. For example, the ore material may contain primarily chalcopyrite with lesser quantities of uranium and gold. In embodiments where the ore material primarily comprises chalcopyrite, the rate of dissolution is typically governed by the rate at which the chalcopyrite dissolves. In an embodiment copper, uranium and gold are recovered concomitantly.

Without wishing to be limited by theory, it is believed that under certain conditions, chlorate ions in solution react with chloride ions to produce low concentrations of dissolved chlorine, in accordance with the following chemical reaction (1):

ClO₃⁻+5Cl⁻+6H⁺ [symbol] 3Cl₂+3H₂O (1)

This reaction is thought to occur in situ, that is, within the leach liquor itself. The rate at which chlorine is generated and the concentration of chlorine generated may be controlled by varying one or more of the chloride, acid and/or chlorate concentrations. It can be advantageous to select each of these parameters such that chlorine generation occurs in a controlled manner and such that the chlorine concentration is at a suitable or desirable level for leaching. In some embodiments, chlorine is generated are a relatively low rate. As explained below, only low concentrations of chlorine may be required to facilitate the dissolution of the ore material. It will be appreciated that high concentrations of chlorine can result in handling issues.

The conventional mixed potential theory for oxidative dissolution appears to be inadequate to explain the enhanced dissolution of refractory ore minerals, e.g. chalcopyrite, which occurs when an acidic, chloride leaching solution comprising chlorate is used as the lixiviant. Instead, without being bound by theory, it is believed that an alternative, non-oxidative process may be operative in which the ore mineral, in this example chalcopyrite, is first leached by acid according to the reaction (2):

CuFeS₂+4H⁺ [symbol] Cu(II)+Fe(II)+2H₂S (2)

The chlorine generated by the reaction of chlorate and chloride in reaction (1) oxidises both the Fe(II) and H₂S generated by reaction (2) according to the following reactions:

2Fe(II)+Cl₂ [symbol] 2Cl⁻+2Fe(III) (3)

H₂S+Cl₂ [symbol] S+2Cl⁻+2H⁺ (4)

In this way, the products of reaction (2) are consumed, thereby displacing the equilibrium to promote the dissolution of chalcopyrite. In the absence of chlorine, the dissolution of chalcopyrite is typically slow. The generation of a chlorine at a low rate may still make a suitable concentration of chlorine available to increase the rate of reaction (2). The increase in rate may be such that there are significant decreases in the overall leaching times required. Advantageously, the product of these reactions are chlorides, which are typically non-toxic. A further advantage is that the sulphide in chalcopyrite is converted into elemental sulphur. As a result, less oxidant (i.e. chlorate) may be required compared to when complete oxidation of sulphide to sulphate occurs.

Without wishing to be limited by theory, and continuing to use chalcopyrite as an example, it is thought that the primary leaching mechanism utilising the chlorine is the non-oxidative process described above, rather than direct oxidation of the chalcopyrite with chlorine. The rate at which chlorine is generated typically result in chlorine concentrations that are relatively low and such a heterogenous reaction would be expected to proceed relatively slowly. On the other hand, because reaction (3) and reaction (4) are homogeneous reactions (i.e. both reactants are in the aqueous phase), they are able to occur relatively quickly. For this reason, it is believed that a non-oxidative leaching reaction followed by oxidation of Fe(II) and H₂S is occurring.

The use of chlorate in a concentrated chloride solution can result in enhanced rates of dissolution of chalcopyrite compared to the use of iron (III) as an oxidant. In particular, the rate of dissolution may be increased by ensuring the rate of chlorine generation by reaction (1) is sufficient to produce chlorine at a rate at least equal to the rate of consumption of chlorine by the oxidation of the Fe(II) and H₂S produced from reaction (2).

Without wishing to be limited by theory, it is thought that similar non-oxidative leaching processes may also occur for other refractory sulphide minerals. For example, base metal sulphides comprised of Co, Ni, Zn etc. may all be leached according to this non-oxidative mechanism.

In the case of precious metals, chlorine may react directly with precious metals present in the ore material. In the case of gold, the overall reaction with chlorine is as follows:

Au+1.5Cl₂+Cl⁻ [symbol] AuCl₄⁻ (5)

The rate of dissolution of gold may be enhanced by the presence of chlorine. Gold tends to dissolve according to a mixed potential model in which the gold reacts directly with chlorine. Even small concentrations of chlorine may be sufficient to leach the gold at moderate to high rates because the concentration of gold in the ore material is typically low.

In the case of uraninite, the overall reaction with chlorine is as follows:

UO₂+Cl₂ [symbol] UO₂²⁺2Cl⁻ (6)

Uraninite is a relatively reactive mineral, i.e. it is not refractory. As such, the presence of chlorine may have a minor effect on dissolution rate for uranium. However, when uranium is present in the form of refractory minerals such as brannerite, the presence of chlorine may increase the rate of dissolution of uranium. Without wishing to be bound by theory, it is thought that refractory uranium minerals may react directly with chlorine and chloride in a similar way as gold, e.g. reaction (5) above.

The use of chlorine to facilitate dissolution may be particularly advantageous when the ore material is refractory. For example, when the ore material comprises chalcopyrite and/or precious metals. The rate of chlorine generation may be controlled to increase the rate of dissolution of these refractory minerals. In some embodiments, the rate of chlorine generation is further controlled to minimise the generation of excess chlorine. This can minimise the loss of excess chlorine to the atmosphere. The rate of chlorine generation is dependent on the composition of the leach liquor comprising acid, chloride and chlorate concentrations.

In an embodiment of the process, the chloride content (concentration) in the leach liquor is a minimum of 1 M or 36 g/L. In an embodiment of the process, the chloride content in the leach liquor is a minimum of 45 g/L. In an embodiment of the process, the chloride content in the leach liquor is preferably a minimum of 50 g/L, more preferably, the chloride content is at least 70 g/L. In an embodiment of the process, the chloride content in the leach liquor is a minimum of 90 g/L. The chloride content may be a minimum of 100 g/L, such as a minimum of 105 g/L. In an embodiment of the process, the chloride content in the leach liquor is a minimum of 130 g/L. In an embodiment of the process, the chloride content in the leach liquor is a minimum of 150 g/L. In one embodiment of the process, the chloride content in the leach liquor ranges from around 70 g/L up to 140 g/L. The chloride content may preferably range from about 90 g/L to about 140 g/L.

In some embodiments of the process, the upper limit of the chloride content in the leach liquor is the solubility limit of the selected chloride salt in the leach liquor. By selecting a chloride content that is less than the solubility limit of the selected chloride salt in the leach liquor, the risk of crystallisation of the chloride salt in the leach liquor may be reduced. Higher chloride contents tend to improve the efficiency of the leach. However, increased chloride contents also tend to increase the amount of chlorate consumed, e.g. see reaction (1). This can lead to the production of excess chlorine.

In some embodiments, the chloride concentration is selected to minimise the amount of chlorate used, whilst still ensuring good rates of chlorine generation. The chloride content may be selected and/or adjusted during leaching to provide a suitable or desirable recovery of target metal(s) from the ore material.

The chloride content in the leach liquor may be at least partially derived from water which naturally contains dissolved chloride salt(s), e.g. water drawn from underground bores, or from the sea or a salt lake or reservoir. Alternatively, the water may be brine, produced for example as a by-product during a desalination process. In some embodiments, the leaching solution includes or comprises a recycled process solution.

In some embodiments, the ore material is leached in a heap leaching operation. In these embodiments, the ore material may be agglomerated prior to forming a heap. Agglomeration may be effected by mixing the ore material with a desired quantity of acidic agglomerating solution to give the agglomerates a desired final moisture content.

In some embodiments, in order to attain the desired chloride concentration in the leach liquor, a solid chloride salt may be added to the ore material during and/or post agglomeration. The solid chloride salt may be one or more of the following NaCl, MgCl₂, KCl and AlCl₃. The salt may be added directly to the ore material (as opposed to the chloride salt being used to prepare a leaching solution applied to the heap). This enables the salt to be then dissolved in situ during active irrigation resulting in the heap acting as a fines filter for any insoluble impurities.

In some embodiments, the chloride salt is NaCl and/or MgCl₂. NaCl and/or MgCl₂ may be more affordable and more readily available compared to the other chloride salts. This may improve the economic feasibility of processes in accordance with the present invention. In some embodiments, the chloride salt is NaCl.

In embodiments where the ore material comprises iron, KCl is not typically selected as the chloride salt. The presence of high concentrations of KCl can result in the precipitation of iron as K-jarosite. In some embodiments, such as embodiments using water naturally containing dissolved chloride salt(s) or brines derived therefrom, the solution may have a mixture of chloride salts, comprising KCl. The source of the water may be selected, or the salt concentration may be adjusted (e.g. by adding supplemental NaCl and/or MgCl₂ and water), in order to provide a solution with a suitable concentration of KCl.

Chlorate may be added to the leach liquor in the form of chloric acid (HClO₃) or any salt thereof, such as sodium chlorate NaClO₃. If the chlorate concentration is too low, there may be low recovery of target metal(s) and/or longer leach times.

The concentration of chlorate in the leaching solution may be greater than 1 g/L ClO₃⁻. In some embodiments, the concentration of chlorate in the leaching solution may be greater than 2 g/L ClO₃⁻. In some embodiments, the concentration of chlorate in the leaching solution may be greater than 3 g/L ClO₃⁻. In some embodiments, the concentration of chlorate in the leaching solution may be greater than 4 g/L ClO₃⁻. In some embodiments, the concentration of chlorate in the leaching solution may be greater than 5 g/L ClO₃⁻. In some embodiments, the concentration of chlorate in the leaching solution may be greater than 7 g/L ClO₃⁻. In some embodiments, the concentration of chlorate in the leaching solution may be greater than 10 g/L ClO₃⁻.

The upper limit on chlorate concentration may be 25 g/L ClO₃⁻. In some embodiments, the concentration of chlorate in the leaching solution may be 20 g/L ClO₃⁻ or lower. In some embodiments, the concentration of chlorate in the leaching solution may be 17 g/L ClO₃⁻ or lower. In some embodiments, the concentration of chlorate in the leaching solution may be 15 g/L ClO₃⁻ or lower. In some embodiments, the concentration of chlorate in the leaching solution may be 12 g/L ClO₃⁻ or lower. Excess chlorate may remain in the leach liquor and may be recovered and/or recycled.

In an embodiment the chlorate concentration of the pregnant leach solution may be assessed, and the chlorate concentration of second leaching solution adjusted. In some embodiments, additional chlorate may be added. Additional chlorate may be added to provide the desired generation of chlorine in situ. The desired generation of chlorine may depend on the composition of the ore material.

Additionally, in some embodiments, the leach liquor may comprise hypochlorite (ClO⁻). For example, hypochlorite may be added to the leach liquor in the form of a hypochlorite salt, such as sodium hypochlorite. Hypochlorite may facilitate the leaching of refractory mineral ores in a similar manner to chlorate.

In some embodiments of the process, the leach liquor further includes iron ions. The iron ions may be added to the leach liquor or may form in situ due to dissolution of iron containing minerals during the leaching process.

The dissolved iron may comprise ferric ions. The ferric ions may function as an oxidant and oxidise one or more target metal(s) in the material ore. For example, it is thought that the ferric ions can oxidise uranium. It is also thought that the ferric ions may also oxidise gold and/or chalcopyrite, albeit at a significantly slower rate.

Thus, in some embodiments, the leaching solution comprises iron (III). The iron (III) may be formed in situ in some embodiments. For example, when the ore material comprises iron (III), the iron (III) will form part of the leach liquor as it is leached from the ore material. Alternatively, or additionally, when the ore material comprises iron (II), leached iron (II) may be oxidised to iron (III) by e.g. chlorine (such as according to reaction (3) above). In some embodiments, a leaching solution (or an irrigation solution) containing iron (III) is formed and brought into contact with the ore material. In these embodiments, the iron (III) may be provided from a recovered or a recycled process solution. For example, the iron (III) may be provided from an earlier leaching step.

As mentioned above, the leaching solution may be formed in situ. In some embodiments, the ore material is agglomerated with acid. The acid provided by the agglomeration is typically only part of the total acid required for the leaching process. In some embodiments, the ore material is agglomerated with acid and a solid chloride salt. The solid chloride salt may provide some, most or substantially all of the chloride required for the leaching process. In some embodiments, an irrigation solution (leaching solution precursor) containing chlorate is applied to the agglomerated ore material so that the leaching solution can form in situ. In some embodiments, the composition of the leaching solution or the leaching solution precursor may be adjusted during leaching to account for the solution composition changes that will occur in situ.

The salinity of the leach liquor, pH and chlorate concentration, as well as the concentrations of iron (III) (if present), all influence the redox potential of the leach liquor.

Typically, leaching of refractory minerals (such as chalcopyrite and gold) occurs only at higher Eh values. In the present invention, the composition of the leaching solution, i.e. the aqueous, acidic, chloride solution containing chlorate, can be selected to provide a suitable Eh for leaching of refractory materials. In some embodiments, a suitably high Eh may be provided by increasing the chlorate concentration. As discussed above, the chlorate and chloride react to form chlorine. The potential is, in part, determined by the ratio of chlorine to chloride. By increasing the concentration of, in particular, chlorate and/or chloride, the ratio of chlorine to chloride and hence the Eh of the solution can also be increased. Also, by increasing the concentration of acid, the Eh can be increased, and the generation of chlorine becomes more favourable. As described above with reference to reaction (1), the rate at which chlorine is generated and the concentration of chlorine generated may be controlled by varying one or more of the chloride, acid and/or chlorate concentrations. Increasing the chlorine generated can increase the rate of leaching of refractory minerals, as discussed above.

In embodiment in which the ore material comprises chalcopyrite, the Eh selected may be a Eh at which sufficient chlorine is present to facilitate the oxidation of Fe (II) and H₂S into Fe (III) and elemental sulphur respectively. As explained above, the oxidation of Fe (II) and H₂S can displace the equilibrium of the acid leaching reaction, thereby promoting chalcopyrite dissolution. Reactive minerals such as uranite may still be leached at lower Eh values, for example even when chlorine generation does not occur, because leaching of these minerals does not tend to occur via the same reaction mechanism, as discussed above.

In some embodiments, the chlorate/chloride/chlorine system present in the leach liquor may help to maintain the solution potential at values that stabilise gold in solution for extended periods.

In some embodiments, the Eh of the leaching solution is greater than 0.85 V. In some embodiments, the Eh is greater than 0.9 V. In some embodiments, the Eh is greater than 0.95 V. In some embodiments, the Eh is greater than 1 V. In some embodiments, the Eh is greater than 1.05 V. In some embodiments, the Eh is greater than 1.1 V. In some embodiments, the Eh is greater than 1.15 V. In some embodiments, the Eh is greater than 1.2 V. In some embodiments, the Eh is greater than 1.25 V.

In some embodiments of the process, the total iron concentration of the leach liquor is >0.1 g/L. The total iron concentration may be at least 1 g/L. The total iron concentration may be at least 2 g/L. The total iron concentration may be at least 4 g/L. The total iron concentration may be at least 5 g/L. In some embodiments, the total iron concentration is at least 20 g/L, such as at least 25 g/L. The total iron concentration may be a maximum of 50 g/L. In some embodiments, the total iron concentration is a maximum of 80 g/L.

In one embodiment the leach liquor further includes copper ions. The copper ions may comprise cupric ions. The copper ions may comprise cuprous ions. Copper ions may assist in the leaching of chalcopyrite and uranium. The copper ions may be added to the leach liquor or may form in situ due to dissolution of copper containing minerals during the leaching process.

The pH of the leaching solution is acidic. The pH of the leaching solution may be effected by the addition of acid directly to the ore during the prior agglomeration process or by the addition of acid to the solution which contacts the ore during irrigation or by using both techniques. The acid may be sulphuric acid. The acid may be hydrochloric acid. The acid may be a combination of sulphuric acid and hydrochloric acid.

The pH of the leaching solution may be less than 3, such as 2 or lower. In an embodiment, the pH may be less than 1. In another embodiment, the pH may be less than 0.5. In another embodiment, the pH may be less than 0.1.

Various means may be used to contact the ore material with the leaching solution. In embodiments in which the ore material is subjected to heap leaching, the solution (of a leaching solution precursor) may be applied to the heap by irrigation.

The leaching process may be carried out under ambient conditions i.e. at temperature and atmospheric pressure conditions of the prevailing environment. The ambient conditions experienced by the ore material may comprise elevated temperatures up to about 50 °C. In some embodiments, the temperature of the leaching process is elevated (above ambient), for example by heating. The temperature may be greater than 20 °C. The temperature may be greater than 25 °C. The temperature may be at least 30 °C, such as at least 40 °C. The temperature may be up to the boiling point of the leaching solution. However, it is generally preferred that the temperatures employed is below 75 °C.

In some embodiments, the leaching process may be carried out for a period of at least 100 days. The leach may extend for up to 150 days. For example, when the leaching process comprises a heap leach, the leaching process may be carried out for a period of 100 days or more.

In other embodiments, the leaching process may be carried out for a period of one to several hours. For example, when the leaching process is undertaken at elevated temperatures.

In some embodiments, the leaching solution further comprises an additional oxidant. Alternatively, or additionally, the process may further comprise contacting the ore material with an additional oxidant. The additional oxidant may comprise an oxygen-containing gas, such as air, or oxygen-enriched air. In the case of oxygen, copper is a catalyst for the oxidation of iron (II) by oxygen. In some embodiments, air (or another oxygen-containing gas mixture) may be sparged through the ore material when treating the ore material with a leaching solution, for at least some of the treatment duration. Air (or another oxygen-containing gas mixture) may be injected into a heap when treating the ore material with a leaching solution, for at least some of the treatment duration.

In some embodiments, the process comprises: providing a heap of the ore material; treating the ore material with the first leaching solution; and treating the residue ore material with the second leaching solution.

In some embodiments, treating the residue ore material is performed at temperature of at least about 20 °C. In some embodiments, the temperature may be less than 75 °C, such as less than about 50 °C. Treating the residue ore material may have a duration of at least 100 days, such as e.g. when the process of the present invention is utilised for heap leaching of ore material.

The process described herein may be used to undertake leaching of a sulphide ore. The leaching solution may be such that chlorine generated therein enhances the dissolution of refractory materials by rapidly oxidising products formed from the non-oxidative leaching of the sulphide ore. For example, when the sulphide ore comprises chalcopyrite, the chlorine oxidises Fe(II) and H₂S. This displaces the equilibrium of the non-oxidative dissolution of chalcopyrite which, in turn, promotes the further dissolution of chalcopyrite.

In a second aspect, there is disclosed process for recovering one or more target metals from an ore material, comprising:
providing an ore material comprising reactive and refractory ore minerals;
treating the ore material in a first stage with a first leaching solution, said first leaching solution being an aqueous, acidic, chlorate-free leaching solution, to leach at least some of the reactive ore minerals and producing a first pregnant leach solution containing one or more of said one or more target metals and a residue ore material that contains at least a major portion of said refractory ore minerals;
treating the residue ore material in a second stage with a second leaching solution, said second leaching solution having a redox potential greater than about 0.80 V and being an aqueous, acidic, chloride leaching solution containing chlorate, and producing a second pregnant leach solution containing said one or more target metals; and
recovering the target metals from the first and second pregnant leach solutions.

Accordingly, in the process of the second aspect, a multi-stage leaching process includes a first stage followed by a second stage, wherein the second stage employs a leaching solution as per the first aspect described herein.

The first stage comprises leaching of an ore material with a leaching solution in the absence of chlorate. The first stage may utilise an oxidant that is different to chlorate.

In the first stage, the oxidant may be conventional. The oxidant may comprise iron (III). In another embodiment, the oxidant may comprise copper (II). In a further embodiment, the oxidant may comprise an iron (III)/copper (II)/O₂ system.

The multi-stage leaching process may be used where the ore material that is being leached comprises both reactive and refractory ore minerals. For example, the ore deposit at Olympic Dam, Australia, contains both reactive and refractory ore minerals. The reactive ore minerals include copper sulphide minerals such as chalcocite (Cu₂S) and bornite (Cu₅FeS₄) and uranium principally in the form of such minerals as uraninite, coffinite and brannerite. The main refractory mineral is chalcopyrite. In the first stage, the leaching solution may include a conventional oxidant, such as iron (III), that is used to oxidise primarily the reactive ore minerals. The first stage may comprise the leaching process described in WO2016/094956, the entire disclosure of which is herein incorporated by reference.

The first stage may be performed until the reactive ore minerals are depleted such that the remaining residue comprises a greater proportion of refractory ore minerals. Depletion of the reactive ore minerals may be identified by monitoring the leaching rate of, e.g. copper. In particular, the leaching rate may become slower, reflecting the greater proportion of refractory ore minerals (such as chalcopyrite) in the residual ore material as the reactive ore minerals become depleted. The residual ore material may then be leached in the second stage. In some embodiment, the second stage leaching is performed by adding chlorate (and optionally chloride) to the leaching solution used in the first stage solution. In other embodiment, a separate leaching solution is provided. A chlorate- and chloride-containing leaching solution may be advantageous for the leaching of the refractory ore minerals, for the reasons outlined above. By using chlorate during only the second stage, the used of chlorate can be optimised. Utilising chlorate in this way may reduce the inefficient consumption of chlorate in leaching reactive ore minerals. Thus, the total amount of chlorate required to leach the target metals can be reduced.

Typically, the majority of the uranium is leached in the first stage, because it is associated with reactive ore minerals. However, advantageously, uranium remaining in the residue ore material subjected to the second stage may then be leached in that second stage. This can increase the overall recovery of uranium.

The use of a chlorate- and chloride-containing leaching solution in the second stage may also enhance the leaching of any precious metals and/or platinum group metals present in the residual ore material, as compared with the leaching rate during the first stage. Precious metals and platinum group metals present in the ore material are typically difficult to leach. Leaching of such metals may be advantageously enhanced by the presence of chlorine generated by the leaching solution. As with the first aspect, in some embodiments, the second leaching solution further comprises an additional oxidant. Alternatively, or additionally, the process may further comprise contacting the residue ore material with an additional oxidant. The additional oxidant may be air. For example, in some embodiments, air (or another oxygen-containing gas mixture) may be sparged through the residue ore material when treating the ore material with a leaching solution, for at least some of the treatment duration. Air (or another oxygen-containing gas mixture) may be injected into a heap when treating the residue ore material with the second leaching solution, for at least some of the treatment duration.

It will be appreciated that the second leaching solution in accordance with the leaching solution of the first aspect. Thus, the second leaching may have a have a composition and/or be formed in the same manner as described above for the first leaching solution.

### BRIEF DESCRIPTION OF THE DRAWINGS

Notwithstanding any other forms which may fall within the scope of the disclosure as set forth in the Summary, non-limiting examples will now be described, to further illustrate embodiments of the present invention, with reference to the accompanying drawings in which:

FIG. 1 shows the potentials of chalcopyrite (Em) and platinum (Eh) electrodes in 4M NaCl+0.1M HCl solution at 30 °C. Copper (II) and iron (III) and iron (II) ions were added as described in Experiment 1. In the case of experiments with chlorate, 0.1M chlorate was added after 100 minutes.

FIG. 2 shows potentiostatic current/time transients for the anodic dissolution of chalcopyrite electrode China VI in 4M NaCl+0.1M HCl solution at 0.82 V and 0.73 V at 30 °C.

FIG. 3 shows the potentials of Cpy (Em) and platinum (Eh) electrodes in 4M NaCl+0.1M HCl solution at 30 °C. 4 g/L iron (III) ions were added initially.

FIG. 4 shows copper produced by dissolution of Cpy in 4 M NaCl+0.1 M HCl solution containing 4 g/L iron (III) at 30 °C.

FIG. 5 shows the effect of chlorate on Cpy and Pt potential measurements in 4M NaCl+0.1M HCl solutions at 30 °C.

FIG. 6 shows copper produced by dissolution of Cpy in 4 M NaCl+0.2 M HCl solution containing 4 g/L iron (III) and 0.21 M chlorate at 30 °C.

FIG. 7 shows the potentials of Cpy (Em) and platinum (Eh) electrodes in 4M NaCl+0.1M HCl solution at 30 °C. 4 g/L iron (III) ions and 0.21 M chlorate were added initially.

FIG. 8 shows copper produced by dissolution of Cpy in 4 M NaCl+0.2 M HCl solution containing 4 g/L iron (III) and 0.21 M chlorate at 30 °C and Eₘ=0.82V.

FIG. 9 shows potentials of Cpy (Em) and platinum (Eh) electrodes in 4M NaCl+0.1M HCl solution at 30 °C. 0.21 M chlorate was added initially.

FIG. 10 shows copper produced by dissolution of Cpy in 4 M NaCl+0.1 M HCl solution containing 0.21 M chlorate at 30 °C.

FIG. 11 shows potentials of Cpy (Em) and platinum (Eh) electrodes in 4M NaCl+0.1M HCl solution at 40 °C. 4 g/L iron (III) and 0.21 M chlorate was added initially.

FIG. 12 shows copper produced by dissolution of Cpy in 4 M NaCl+0.1 M HCl solution containing 4 g/L iron (III) and 0.21 M chlorate at 40 °C.

FIG. 13 shows the effect of the addition of sodium chlorate on the leaching of copper in copper concentrate (1) in acidic sodium chloride solution containing iron (III).

FIG. 14 shows the effect of the addition of sodium chlorate on the leaching of copper, gold, uranium and sulphur in copper concentrate (2) in acidic sodium chloride solution containing iron (III).

FIG. 15 shows the effect of the addition of sodium chlorate on the leaching of copper, gold, uranium and sulphur in copper concentrate (2) in acidic sodium chloride solution containing iron (III).

FIG. 16 shows the potentials of gold (Em) and platinum (Eh) electrodes in 4M NaCl+0.1M HCl solution at 30 °C. 3 g/L copper (II) and 2.5 g/L iron (III) ions were added initially. In the case of experiments with chlorate, 0.085M chlorate was added after 30 minutes.

FIG. 17 shows the potentials of gold (Em) and platinum (Eh) electrodes in 4M NaCl+0.1M HCl solution at 30 °C. 3 g/L copper (II) and 2.5 g/L iron (III) ions were added initially. In the case of experiments with chlorate, 0.042M chlorate was added after 200 minutes.

FIG. 18 shows the effect of acid concentration on the rate of chlorine generation in a solution of 4 M NaCl and 0.1 M sodium chlorate at 30 °C.

FIG. 19 shows the effect of chloride concentration on the rate of chlorine generation in a solution of 0.3M HCl and 0.1 M sodium chlorate at 30 °C.

FIG. 20 shows the effect of chlorate concentration on the rate of chlorine generation in a solution of 4M NaCl and 0.1M HCl at 30 °C.

FIG. 21 shows the effect of leaching of copper and uranium from a flotation tailing with a solution comprising chlorate and chloride at a temperature of 70 °C.

FIG. 22 shows leaching of copper and uranium from a flotation tailing with chlorate and reduced chloride concentration at 70 °C.

### EXAMPLES

Non-limiting Examples of a process for recovering a target metal from an ore material will now be described.

### Examples 1 to 9: Recovery of Copper

In the following Examples, high purity chalcopyrite mineral samples from Hezhang Guizhou (China) were treated using different electrolytes (leaching solutions). The samples were identified as alpha chalcopyrite by using XRD analyses. Several samples were fabricated into roughly cylindrical electrodes using silver epoxy as the contact between the mineral and a stainless-steel stud both of which were encased in epoxy resin. The electrodes, which varied in surface area from 0.08 to 0.5 cm², were attached to a rotating disk holder. Most experiments were conducted with a sample that had an area of 0.50 cm².

The electrolytes consisted of various concentrations of HCl and NaCl. In addition, the solutions contained iron (III), iron (II) or copper (II). For the preparation of the electrolytes, analytical grade reagents HCl, CuCl₂·2H₂O, FeCl₃·xH₂O, FeCl₂·xH₂O, and NaCl were used with de-ionized water.

Potentiostatic measurements were performed using a standard three electrode system with a rotating electrode stand and a 100 mL double jacketed glass cell maintained at 30 °C by circulation of water from a thermostatted water bath. Unless stated otherwise, the electrode was rotated at 200 rpm. The chalcopyrite disk electrode was used as the working electrode and a silver/silver chloride electrode (3 M KCl. 0.210 V versus SHE) as the reference. All potentials are quoted versus standard hydrogen electrode (SHE). A coiled platinum wire, used as the counter electrode, was housed in a glass tube with a glass frit at the bottom to separate the electrode from the bulk solution in cell. Experiments were carried out using a Solartron 1285 potentiostat with Corrware software. Potentiometric measurements were made using the same cell except the open-circuit potentials of the chalcopyrite (Eₘ) and platinum (Eₕ) were recorded against the same reference electrode using a high impedance 16-bit National Instruments data acquisition board linked to Labview.

Before all experiments, the electrolyte (about 10-20 mL) was maintained at 30 °C with a water bath for at least 20 minutes. Fresh electrode surfaces were prepared by wet grinding using #1200 followed by #2000 emery paper.

In the case of the potentiometric measurements, the mixed potential and the solution potential were monitored in the base electrolyte of 4M NaCl+0.1M HCl with the addition sequentially of 2 g/L copper (II), 2 g/L iron (III) and 0.1 g/L iron (II) at intervals of about 20 minutes. For those experiments in which the base electrolyte also included chlorate, after a further 20 minutes, a fixed amount of 0.1M NaClO₃ was added, and the potentials monitored for an additional hour or longer in some cases.

For the dissolution experiments, a similar thermostatted mini cell with an active volume of 6 mL was used. In this case the electrode was not rotated but the solution stirred with a small magnetic stirrer. The rate of dissolution was obtained by AA analysis of the solution for copper after fixed times. In these experiments, copper ions could not be added initially due to the low concentrations of copper (less than 100 ppm) in solution after dissolution for up to 4 days.

### Example 1: Leaching in NaCl/HCl/Cu(II)/Fe(III)/Fe(II)/NaClO₃ Solution

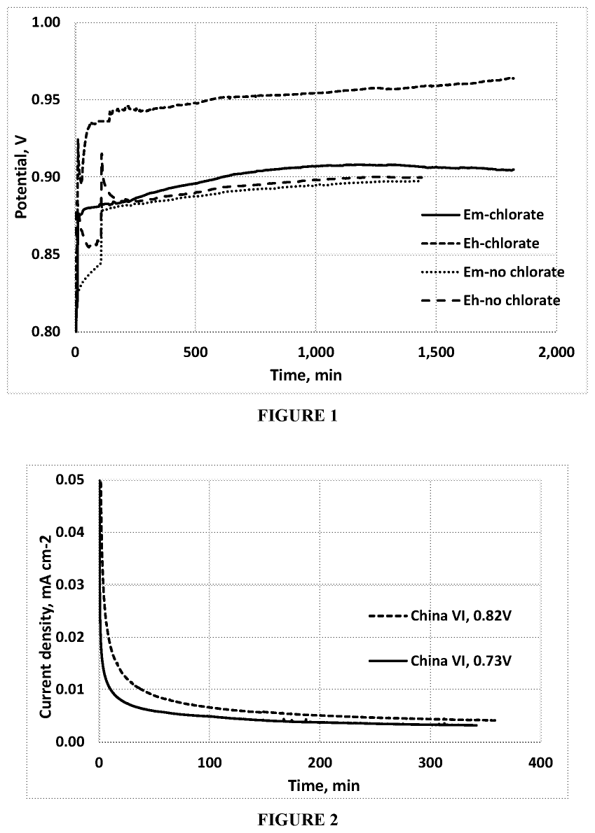

The effect of sodium chlorate (0.1 M) as an oxidant is shown by the results in FIG. 1 in which the potential of Cpy and platinum electrodes are plotted as a function of time in a solution of 4M NaCl+0.1M HCl sparged initially with nitrogen. After 10 minutes, copper (II) was added to give 2 g/l copper (II). After 25 minutes 2 g/L iron (III) was added and then 2 g/L iron (II) was added after 40 minutes. 0.1 M sodium chlorate was added after 100 minutes. The Cpy potential increased somewhat to about 0.71 V and then decayed somewhat to 0.695 V before increasing slowly to close to 0.72 V as the Eh also increased to above 0.95 V. As will be demonstrated below, these potentials increase slowly and are maintained for at least 100 hours even in solutions containing lower chlorate concentrations. Thus, the results indicate that chlorate is an effective and stable oxidant.

### Example 2: Dissolution of Cpy in NaCl/HCl Solution

Potentiostatic experiments were conducted at mixed potentials recorded during the dissolution experiments (see below). The results of typical potentiostatic experiments using the chalcopyrite electrode are shown in FIG. 2 that shows potentiostatic current/time transients for the anodic dissolution of chalcopyrite electrode in 4M NaCl+0.1M HCl solution at 0.82 V and 0.73 V at 30 °C. The initial rapid decay in current is followed by a slow decrease over many hours to values that are about 10× less than that for gold under similar conditions and emphasizes the problem with chalcopyrite leaching. A previously developed method for the prediction by extrapolation of the current at long times gave values close to 2.0 μA cm⁻² at 0.82 V and 0.8 μA cm⁻² at 0.73 V.

Those current densities can be converted to dissolution rates using Faraday's Law to give values of 4.1×10⁻¹² and 1.7×10⁻¹² mole Cpy cm⁻² s⁻¹ respectively assuming 5e/mole Cpy (where Cpy means chalcopyrite) according to the reaction (7):

CuFeS₂ [symbol] Fe(III)+Cu(II)+2S+5e (7)

### Example 3: Leaching in NaCl/HCl/Fe(III) Solution

Example 2 shows that chlorate is an effective oxidant. Several additional experiments were conducted to confirm the positive effect of chlorate on the dissolution of Cpy. In these experiments, a chalcopyrite electrode was used in a magnetically agitated mini cell containing 6 mL of solution. The cell also contained platinum and reference electrodes. Copper ions could not be added as this would make analysis of the low copper concentrations produced almost impossible. The Cpy and platinum potentials were monitored over extended periods and samples of solution taken every 24 hours, diluted, and analysed for copper using AA spectrophotometry. The same experiment was repeated with the addition of sodium chlorate under several conditions.

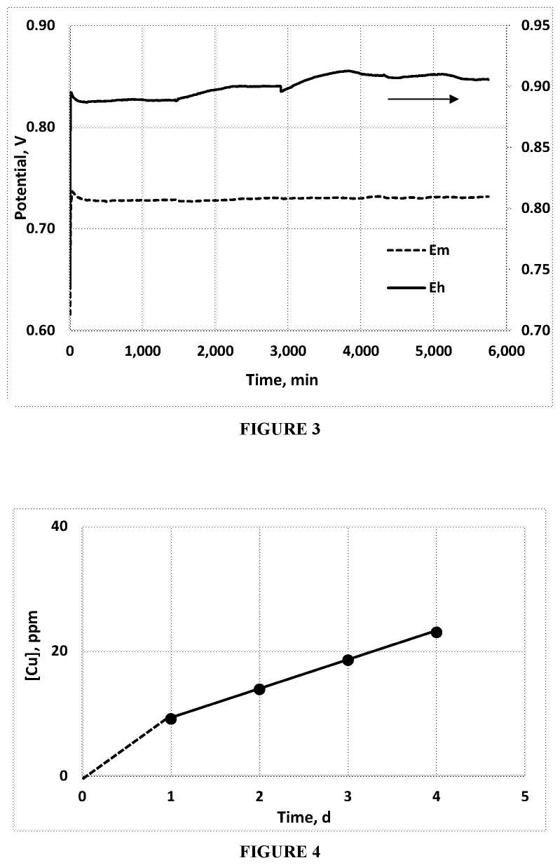

The results of the first of these two experiments are shown in FIG. 3, in which the potentials of Cpy (Em) and platinum (Eh) electrodes are plotted against time. Chalcopyrite was dissolved at 30 °C using a 4M NaCl+0.1M HCl solution to which 4 g/L iron (III) ions were added initially. Both potentials were reasonably constant over the 4-day period with the Eh (ranging from about 0.89 to 0.92 V) being about 100 mV more positive than Em which was about 0.73 V. Analysis of the solution every 24 hours for copper gave the results shown in FIG. 4. Except for an initial more rapid dissolution, the rate is approximately constant, and the slope gives an estimated dissolution rate of 1.27×10⁻¹¹ mole Cpy cm⁻² s⁻¹.

In order to compare this rate with that estimated from electrochemical measurements, the same electrode was potentiostatted at 0.73 V in a solution of 4M NaCl+0.1 M HCl and the result shown as the solid line in FIG. 2. Extrapolation of this trend to long times yielded a value of 1.5×10⁻³ mA cm⁻². This can be converted to a chemical rate using Faraday's law to give 3.1×10⁻¹² mole Cpy cm⁻² s⁻¹. Thus, the actual measured rate is some 4× greater than that estimated using the mixed potential theory that assumes a direct reaction of the oxidant (iron (III) in this case) with the mineral.

### Example 4: Leaching in NaCl/HCl/Fe(III)/NaClO₃ Solution

Similar experiments to those in Example 3 were carried out in which sodium chlorate was also added in addition to iron (III). The results of the potential measurements are shown in FIG. 5. The Cpy potential (Em) is somewhat higher (0.77 to 0.79 V) in the presence of chlorate while the Eh is significantly higher (1.23 to 1.24 V) and did not appear to decrease even after 4 days.

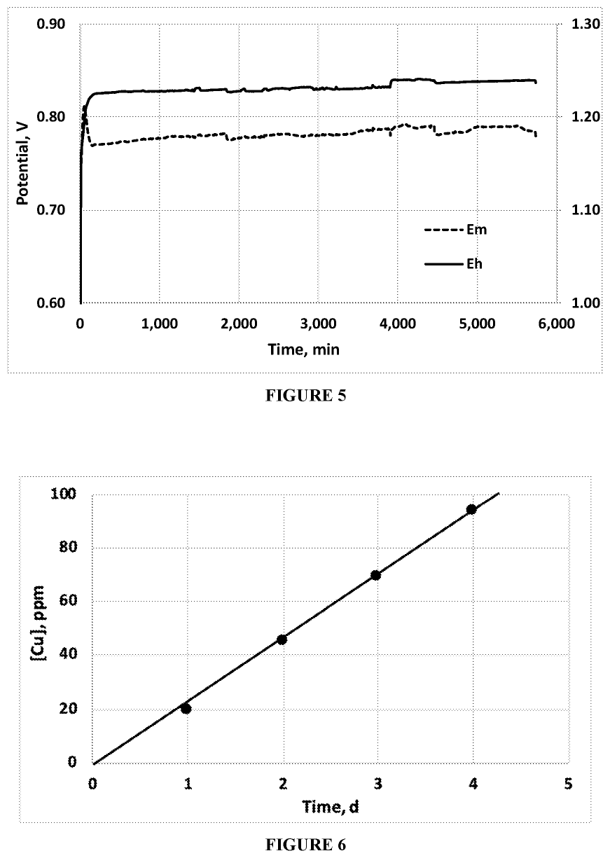

The rate of dissolution as measured by the copper dissolved (FIG. 6) was also higher than in Example 3 and was 1.75×10⁻¹¹ mole Cpy cm⁻² s⁻¹. No potentiostatic measurements were made under these conditions.

### Example 5: Effect of Increased Acid Concentration

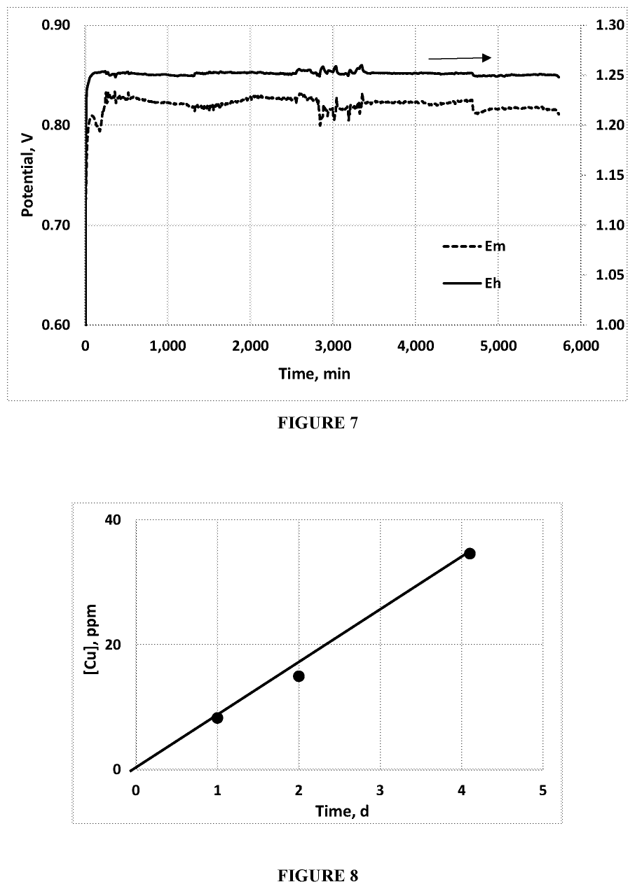

An additional experiment was conducted in which the acid concentration was increased from 0.1 to 0.2 M and the results are shown in FIGS. 7 and 8. Both potentials were higher at the higher acidity with that of Cpy (Em) averaging about 0.82 V and that of Eh averaging about 1.25 V. Analysis of the solution every 24 hours for copper gave the results shown in FIG. 8. The rate of dissolution from these data is 5.4×10⁻¹¹ mole Cpy cm⁻² s⁻¹. This value is about three times greater than that at a lower acidity of 0.1 M as discussed in Example 4.

Potentiostatic measurements at 0.82 V yielded the dotted curve shown in FIG. 2 from which a value of 2×10⁻³ mA cm⁻² was obtained by extrapolation. This yields an estimated rate of dissolution of 4.1×10⁻¹² mole Cpy cm⁻² s⁻¹ that is some 13× less than observed from the dissolution experiment.

### Example 6: Absence of Iron and Copper

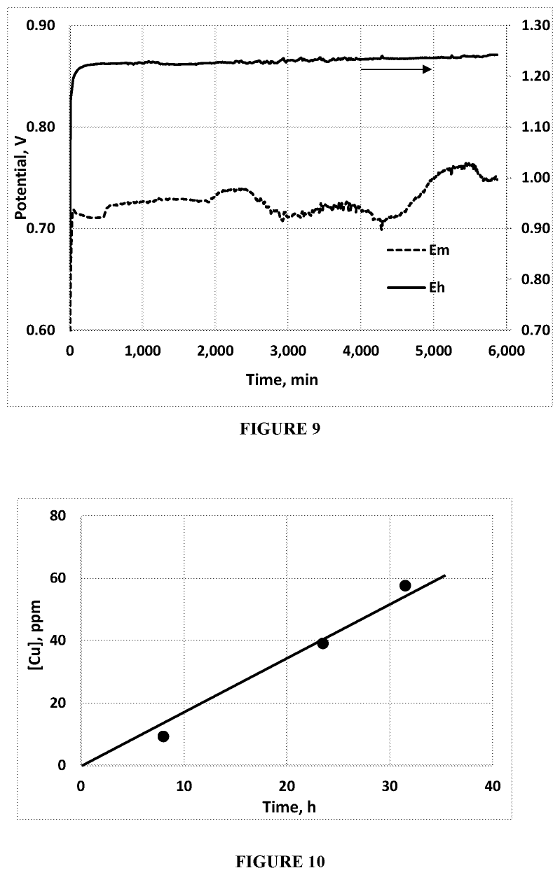

A further experiment was conducted in which no iron (II) nor copper (II) was added i.e., only chlorate is present as an oxidant. The results are shown in FIGS. 9 and 10. The potentials are similar to those measured in the presence of iron (III) in Example 3 with some scatter of the mixed potential (the increase for the last day was probably the result of concentration due to evaporation).

Analysis of the solution over a period of 4 days for copper gave the results shown in FIG. 10. The rate of dissolution from these data is 1.8×10⁻¹¹ mole Cpy cm⁻² s⁻¹. This value is similar to that of 1.75 mole Cpy cm⁻² s⁻¹ obtained in Example 4 in the presence of iron (III) and chlorate. This experiment indicates that chlorate has a greater influence on the rate of dissolution than Fe (III) and that chlorate is effective in the absence of Fe (III).

### Example 7: Effect of Temperature

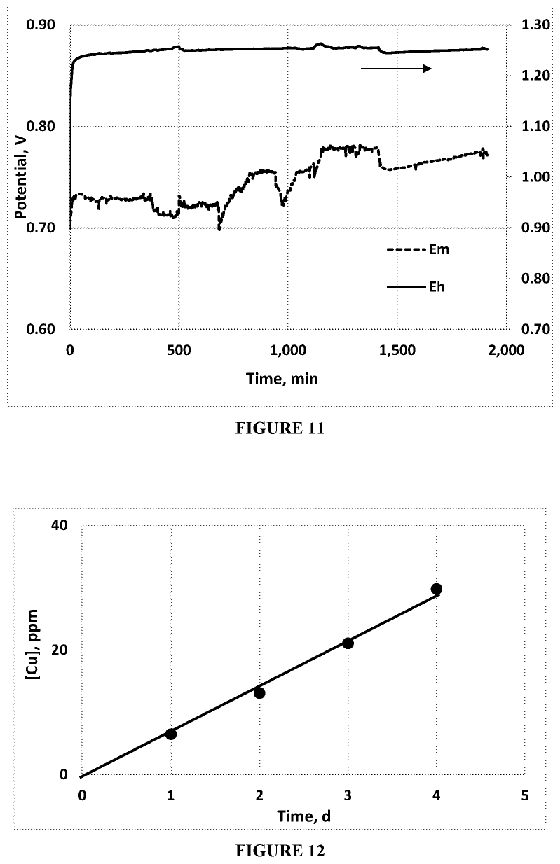

A dissolution experiment was carried out over 2 days at a higher temperature of 40 °C and the results shown in FIGS. 11 and 12. FIG. 11 is a plot of potentials of Cpy (Em) and platinum (Eh) electrodes in a 4M NaCl+0.1M HCl solution at 40 °C. 4 g/L iron(III) and 0.21 M chlorate were added to the solution initially. FIG. 11 shows that both potentials are higher than those observed at 30 °C: the Em averaged around 0.74 V and the Eh averaged around 1.25 V.

Similarly, the rates of dissolution shown in FIG. 12 are higher than those at 30 °C, giving a rate of dissolution of 7.5×10⁻¹¹ mole Cpy cm⁻² s⁻¹ that is some 4 times that at 30 °C. This indicates a very significant effect of temperature on dissolution rate.

### Example 8: Leaching of Copper Concentrate (1)

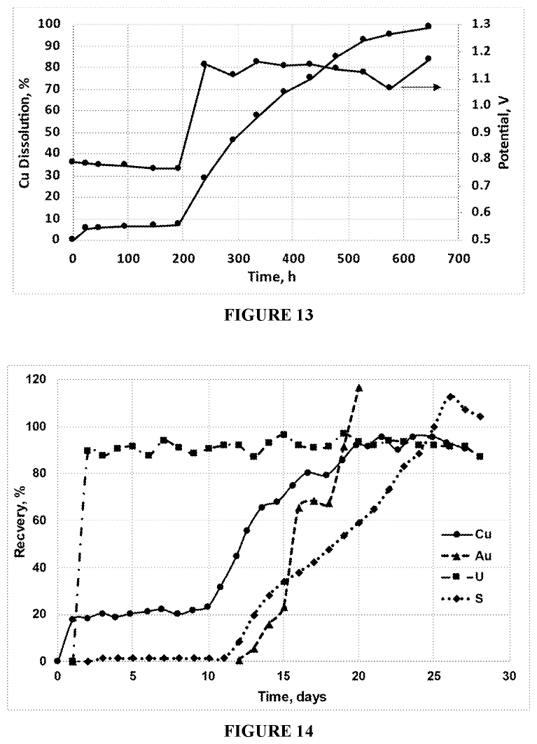

A copper concentrate (particle size between 25 and 38 micrometers), containing 95% of the copper as chalcopyrite and 5% as bornite, was leached in a stirred reactor at 30 °C. Bornite is a reactive mineral and chalcopyrite is a refractory mineral. The lixiviant consisted of 230 g/L sodium chloride and 0.2 mol/L hydrochloric acid containing 5.6 g/L iron(III). Solution samples were taken at regular intervals and analysed for copper. The results are shown in FIG. 13 as a plot of the copper extracted as a function of time.

The initial rapid dissolution of about 5% is due to the leaching of bornite. When bornite was depleted, the leaching rate decreased significantly thereafter as the chalcopyrite slowly dissolved with only about 1% dissolution in about 160 hours. After 190 hours, 0.2 mol/L sodium chlorate was added, and the leaching rate increased significantly thereafter with 100% dissolved in the subsequent 450 hours.

### Example 9: Leaching of Copper Concentrate (2)

A second copper concentrate (particle size between 25 and 38 micrometers), containing 90% of the copper as chalcopyrite and 5% as chalcocite, 4.71 g/t of gold, 396 g/t of uranium as U₃O₈ and 33.8 g/t silver was leached in a stirred reactor at 30 °C. In this case, the leaching of copper, gold and uranium were monitored.

The lixiviant consisted of 230 g/L sodium chloride and 0.5 mol/L hydrochloric acid containing 5.6 g/L iron (III). Solution samples were taken at regular intervals and analysed for copper. The results are shown in FIG. 14 as a plot of the copper extracted as a function of time.

The initial rapid dissolution of about 20% is due to the leaching of reactive minerals comprising chalcocite and bornite. When these (reactive) minerals were depleted, the leaching rate decreased significantly thereafter as the chalcopyrite, which is highly refractory, slowly dissolved with only about 1% dissolution in about 10 days. Thereafter, 0.1 mol/L sodium chlorate was added, and the leaching rate increased significantly with about 95% dissolved in the subsequent 10 days. The results in FIG. 14 also confirm that almost complete dissolution of uranium occurs even in the absence of chlorate and that the dissolution of gold is very rapid after addition of chlorate. The rate of oxidation of sulphide sulphur to soluble sulphate occurs at a similar rate of copper dissolution. The oxidation of sulphide to soluble sulphate is given by the following reaction:

CuFeS₂+2.83ClO₃⁻+H⁺ [symbol] Fe(III)+Cu(II)+2SO₄²⁻+0.5H₂O+2.83Cl⁻ (8)

The above reaction consumes more chlorate than that when sulphur is the product of oxidation, as occurs when chalcopyrite reacts according to the reaction:

CuFeS₂+0.83ClO₃⁻+5H⁺ [symbol] Fe(III)+Cu(II)+2S+2.5H₂O+0.83Cl⁻ (9)

The dissolution of silver was only monitored towards the end of the experiment with an estimated 90% recovery.

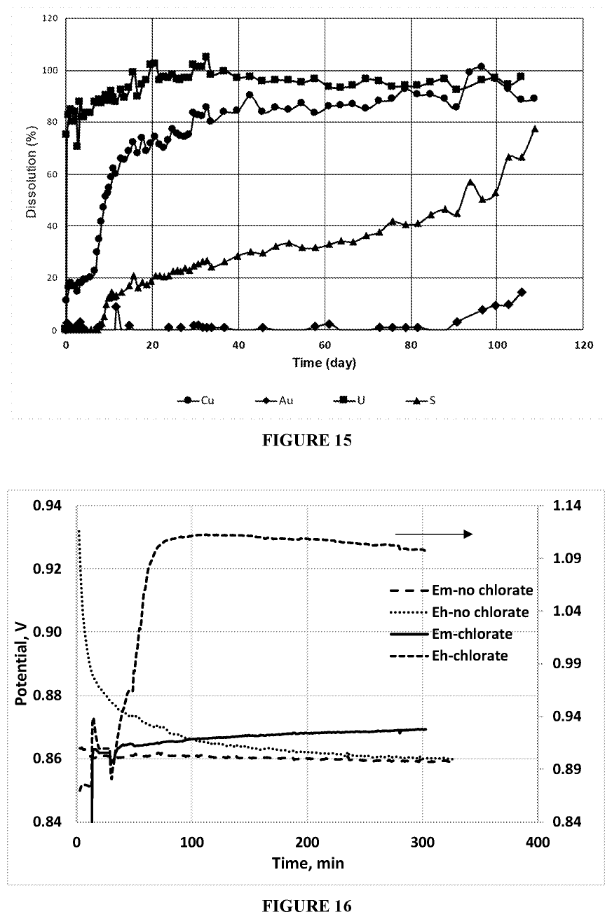

A subsequent experiment under the same conditions but with a lower sodium chloride concentration of 57 g/L gave the results shown in FIG. 15. In this case, chlorate was added after 8 days, and both copper and uranium were effectively leached in about 40 to 60 days. Gold was not dissolved under these conditions of low chloride concentration and the rate of sulphur oxidation to sulphate was considerably slower than at the higher chloride concentration. After 60 days, the chloride concentration was incrementally increased and attained about 200 g/L after 90 days. Gold dissolution was subsequently observed and was accompanied by increased rate of sulphur oxidation. Thus, although the consumption of chlorate was reduced at lower chloride concentration, gold dissolution was severely reduced. Subsequent experiments have shown that this is due to the formation of a passivating layer of gold sulphide. Silver recovery was not affected by the reduced chloride concentration with an overall recovery in excess of 90%.

The above results have confirmed that the use of chlorate in a concentrated chloride solution results in enhanced rates of dissolution of chalcopyrite compared to the use of iron (III) as an oxidant. The effect of copper (II) has not been evaluated given that it could not be included due to analytical restrictions. It appears that iron (III) is not necessary in the presence of chlorate but would, in any event, be a component of any heap leach solution, given the presence of iron in many ore minerals (e.g., chalcopyrite contains iron) and gangue minerals. Other experiments have shown that the rate of dissolution of chalcopyrite is enhanced by increased concentrations of chloride, chlorate and acid.

Again, without wishing to be bound by theory, the considerably higher measured rates of dissolution than estimated from the electrochemical measurements is an important observation from a mechanistic point of view. Thus, the conventional mixed potential theory for oxidative dissolution appears to be inadequate in this case. An alternative, non-oxidative process is probably operative in which chlorine generated by the reaction of chlorate with chloride rapidly oxidises both iron (II) and H₂S produced by the reaction:

CuFeS₂+4H⁺ [symbol] Cu(II)+Fe(II)+2H₂S (2)

thereby displacing the equilibrium and allowing continued rapid dissolution of chalcopyrite.

This mechanism will only be applicable if the rates of oxidation of iron (II) and/or H₂S are rapid to enable the dissolution process to proceed at the desired rate.

The rate of oxidation of iron (II) with chlorine, given by the following reaction:

2Fe(II)+Cl₂ [symbol] 2Cl⁻+2Fe(III) (3)

was measured by an electrochemical technique in 4M NaCl+0.4M HCl and a rate constant of 5.1×10² M⁻¹ s⁻¹ was obtained assuming that the reaction is first order in both iron (II) and chlorine. A further experiment in a solution of 4M NaCl+0.1M HCl yielded a rate constant of 6.0×10² M⁻¹ s⁻¹. This rapid rate appears to be approximately independent of acid concentration.

The rate of oxidation of H₂S with chlorine, given by the following reaction:

H₂S+Cl₂ [symbol] S+2Cl⁻+2H⁺ (4)

[symbol]

was extremely fast and could not be measured by the same technique, as the reaction was complete within the time of mixing (<0.5 s). However, one can estimate a second-order rate constant for the reaction at equal initial concentrations (8.5×10⁻⁶ M) of 1×10⁵ M⁻¹ s⁻¹. Without being limited by theory, it is thought that this is a lower limit.

### Examples 10 and 11: Recovery of Gold

Additional experiments were conducted to show the positive effect of chlorate on the dissolution of gold. In these experiments, a gold rod electrode was used in a magnetically agitated mini-cell containing 5 mL of solution. The cell also contained platinum and reference electrodes.

### Example 10

In a typical experiment, the base chloride solution was added followed by copper (II) and iron (III) to give concentrations of about 3 g/L of copper and 2.5 g/L iron. The gold and platinum potentials were monitored over periods from 2 to 30 hours after which a sample of the solution was analysed for gold using AA spectrophotometry.

The same experiment was repeated with the addition of 0.085 M sodium chlorate (7 g/L ClO₃⁻). The results of these two experiments are compared in FIG. 16.

In the absence of chlorate, the gold potential started slightly above 0.86 V and decreased slowly to about 0.858 V after 5.5 h. The Eh decreased from about 0.93 V to 0.86 V over the same period. This decrease is due to reduction of iron (III) to iron (II) by reaction with gold:

Au+Fe(III)+2Cl⁻ [symbol] Au(Cl₂)⁻+Fe(II) (10)

After 5.5 h, the potentials were effectively the same and the dissolution of gold ceased. Analysis of the solution gave 12.8 ppm or 65 μM gold. From the decrease in Eh, the concentration of iron (II) formed was also 65 μM confirming the stoichiometry of the above dissolution equation.

Addition of chlorate resulted in an immediate increase in Eh to above 1.1 V while the gold potential also increased and continued to increase to about 0.87 V after 5 h. These observations confirmed that chlorate increased the rate of dissolution and that dissolution continued over extended periods. Analysis of the solution after 5.5 h gave a gold concentration of 50.1 ppm or 254 μM. Thus, not only is the leaching rate some 4× greater over this period but, more importantly, gold continued to dissolve in the presence of chlorate whereas it would have almost reached equilibrium in the absence of chlorate.

### Example 11

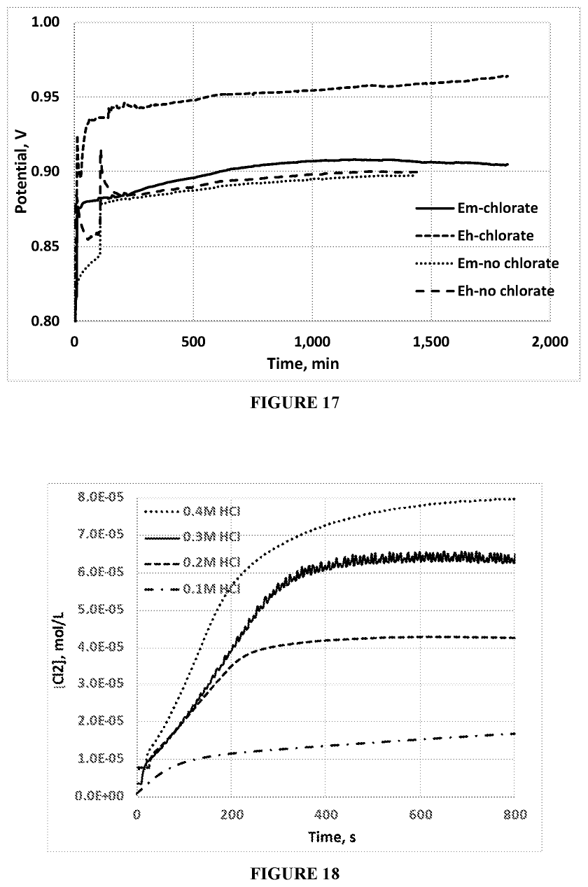

The results of similar experiments to those described in Example 10 and conducted over 24 h are shown in FIG. 17. In this case the concentration of chlorate was reduced to 4.5 g/L ClO₃⁻. As in Example 10, in the absence of chlorate, the potentials converged after a few hours after addition of iron (III) and the rate of gold dissolution decreased to almost zero. However, in the presence of chlorate, the gold potential increased and the Eh continued to increase over the extended period.

Analysis of the solutions after about 6 h and at the end of each experiment gave the results shown in Table 1.

TABLE 1
Analyses of leach solutions (ppm gold)

| | 6 h | 24 h |
|---|---|---|
| No chlorate | 26 | 39 |
| Chlorate | 100 | 442 |

These results confirm the qualitative predictions from the potential measurements. Thus, the rate of dissolution in the absence of chlorate decreased substantially after 6 hours whereas it continued at approximately the same rate for the full period in the presence of chlorate. The rate in the presence of only 4.5 g/L ClO₃⁻ over 24 hours is some ten times that in the absence of chlorate.

### Examples 12, 13, 14: Factors Affecting Chlorine Generation

Additional experiments were performed to show how (individually) changing the acid concentration, chloride concentration and chlorate concentration of the leaching solution affects the concentration of chlorine generated.

It was noted that the active oxidant in the chlorate/chloride system was aqueous chlorine generated in situ by the general reactions:

Cl⁻+ClO₃⁻+2H⁺ [symbol] ClO₂+0.5Cl₂+H₂O (11)

ClO₃⁻+5Cl⁻+6H⁺ [symbol] 3Cl₂+3H₂O (12)

The relative proportions of chlorine dioxide and chlorine as products dependent on the concentrations. At high chloride/chlorate ratios and low acidities (e.g. less than about 1M), chlorine was the predominant product, i.e. reaction (1). It was noted that no chlorine dioxide was detected under the conditions tested.

In these experiments, a rotating vitreous carbon electrode was used to monitor the current due to the reduction of chlorine formed by reaction (1). The potential was set to 0.81 V. At this rate, chlorine reduction was mass transport controlled, as evidenced by the effect of rotation speed on the limiting current density. The cell used was not sealed and therefore chlorine gas could escape, which complicated analysis of the data. Nevertheless, the experiments provided a qualitative understanding of how the acid, chloride and chlorate concentrations all affect chlorine generation.

The chlorine concentration was calculated from the observed current density using the Levich equation for mass transport to a rotating disk using a diffusion coefficient of 1.5×10⁻⁵ cm² s⁻¹ for aqueous chlorine. This approach was checked by adding known amounts of standardized hypochlorite solution to the 4M NaCl solution and measuring the limiting currents. This experiment also showed that, at this potential, the trichloride ion is not reduced and the observed currents are due solely to the reduction of aqueous chlorine.

In all cases, the rate of chlorine generation was initially rapid but decayed after some time, eventually becoming negative as chlorine is lost to the gas phase. In this case, it was noted that the only species with an appreciably changing concentration was chlorine because both chloride and chlorate were present in great excess. Thus, it was concluded that the rate decreased with accumulating chlorine. It was noted that the low chlorine concentrations generated by this reaction did not pose any major problems with the environment and health.

### Example 12: Acid Concentration

To test the effect of acid concentration on the rate of chlorine generation, varying quantities of HCl were added to a leach liquor containing 4M NaCl and 0.1M sodium chlorate at a temperature of 30 °C. The chlorine concentration as a function of time is shown in FIG. 18. The effect was not linear with a large increase in the initial rate on increasing the acid concentration from 0.1 to 0.2M HCl and lower increases up to 0.4 M HCl. Because of the loss of chlorine at long times and higher chlorine concentrations, it was not possible to reliably estimate the effect of acidity on the rates during the second slow phase of the reaction.

### Example 13: Chloride Concentration

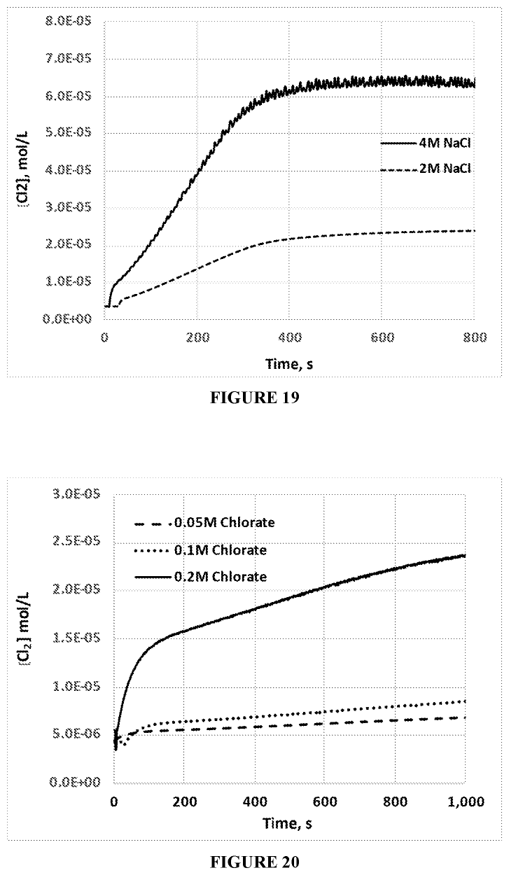

To test the effect of chloride concentration on the rate of chlorine generation, varying quantities of NaCl were added to a leach liquor containing 0.3M HCl and 0.1M sodium chlorate at a temperature of 30 °C. The chlorine concentration as a function of time is shown in FIG. 19. There was a large increase in the initial rate when the chloride concentration was increased from 2 to 4M NaCl. It was observed that doubling the chloride concentration nearly tripled the maximum chlorine concentration measured. In this regard, the chloride concentration had a significant influence on chlorine generation.

### Example 14: Chlorate Concentration

To test the effect of chlorate concentration on the rate of chlorine generation, varying quantities of sodium chlorate were added to a leach liquor containing 4M NaCl and 0.1M HCl at a temperature of 30 °C. The chlorine concentration as a function of time is shown in FIG. 20. Under these conditions, the rate showed a positive dependence on chlorate concentration, especially at the higher concentrations. Again, the effect was not linear with the increase in the initial rate on increasing the chlorate concentration from 0.1M to 0.2M being considerably higher than the increase observed when the concentration was increased from 0.05M to 0.1M.

### Examples 15, 16: Leaching of Flotation Tailings

Additional experiments were conducted to show how an acidic solution containing chloride and chlorate could be used to leach copper, gold and/or uranium from flotation tailings. The flotation tailings contained 0.14% copper, mainly in the form of chalcopyrite, 0.18 g/t gold and 649 g/t uranium (as U₃O₈). The flotation tailings were leached in a solution comprising 18 g/L NaClO₃, 7 g/L HCl and different concentrations of NaCl, at a temperature of 70 °C. The chlorate was added after 15 minutes.

### Example 15: Leaching of Flotation Tailings (1)

In this example, the flotation tailings were leached using a solution comprising 230 g/L NaCl. The results for the dissolution of copper and uranium are shown in FIG. 21. Also shown is the solution potential during the leach. A sharp increase in the rate of dissolution was observed after the addition of chlorate, again confirming that an acidic leach solution containing chloride and chlorate is effective at leaching refractory minerals such as chalcopyrite, as well as gold and uranium. The potential was observed to increase with the addition of chlorate. This was attributed to the generation of chlorine gas.

Analysis of the head and residue samples from the leach showed that over 90% of the copper and uranium and 100% of the gold was recovered. This indicated that acidic leach solutions containing chloride and chlorate were effective lixiviants for leaching materials with low concentrations of target metals.

### Example 16: Leaching of Flotation Tailings (2)

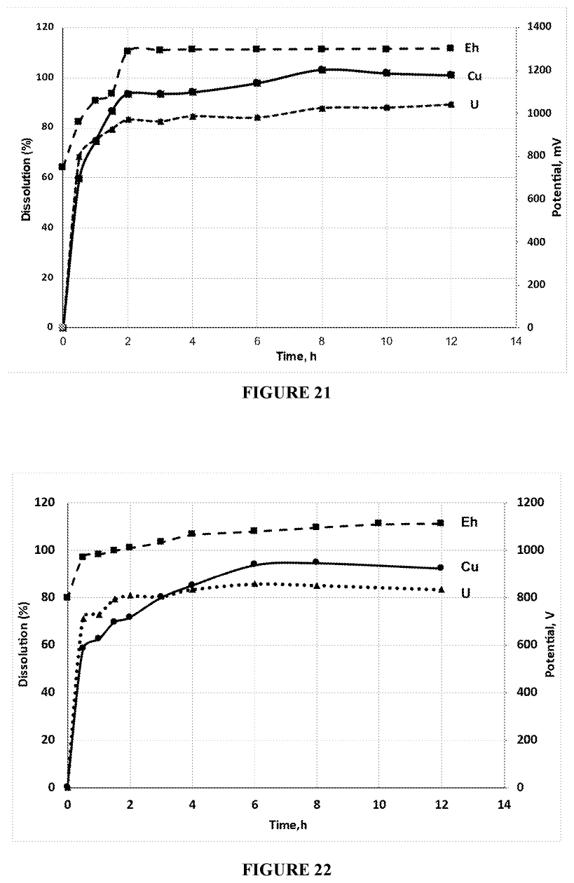

In this example, the flotation tailings were leached using a solution comprising 58 g/L NaCl. The results for the dissolution of copper and uranium are shown in FIG. 22. Also shown is the solution potential during the leach. Again, a sharp increase in the rate of dissolution was observed after the addition of chlorate, again confirming that an acidic leach solution containing chloride and chlorate is effective at leaching refractory minerals such as chalcopyrite, as well as gold and uranium. The potential was observed to increase with the addition of chlorate. This was attributed to the generation of chlorine gas. However, the potential was less than that in Example 15, because of the lower chloride concentration.

Analysis of the residue from the leach showed that 100% of the gold had been dissolved with over 90% of the copper and uranium recovered. This indicated that the chloride concentration impacted the recovery of copper and uranium, with lower recoveries observed at the lower chloride concentration. It was noted that the gold recovery was not affected as much, because gold was present in only very low concentrations.

Whilst a number of specific process embodiments have been described, it should be appreciated that the process may be embodied in many other forms.

In the claims which follow, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features in various embodiments of the apparatus and method as disclosed herein.

1. A process for recovering a target metal from an ore material, comprising:
treating the ore material with a leaching solution, said leaching solution having a redox potential greater than about 0.80 V and being an aqueous, acidic, chloride solution containing chlorate, to produce a pregnant leach solution of the target metal; and
recovering the target metal from the pregnant leach solution.

2. The process according to claim 1, wherein treating the ore material comprises:
providing a heap of the ore material;
treating the ore material with the leaching solution.

3. The process according to claim 1, wherein treating the ore material is performed at temperature below 75 °C.

4. The process according to claim 1, wherein the concentration of chlorate in the leaching solution is between about 1 g/L ClO₃⁻ to about 25 g/L ClO₃⁻.

5. The process according to claim 1, wherein a chloride concentration of the leaching solution is from about 90 g/L to about 140 g/L.

6. The process according to claim 1, wherein the leaching solution further comprises one or more of iron, copper and/or an additional oxidant.

7. (canceled)

8. (canceled)

9. The process according to claim 1, comprising forming the leaching solution in situ.

10. The process according to claim 1, wherein the target metal is a combination of copper, uranium and gold.

11. The process according to claim 1, wherein the ore material comprises one or more of chalcocite, bornite and/or chalcopyrite.

12. A process for recovering one or more target metals from an ore material, comprising:
providing an ore material comprising reactive and refractory ore minerals;
treating the ore material in a first stage with a first leaching solution, said first leaching solution being an aqueous, acidic, chlorate-free leaching solution, to leach at least some of the reactive ore minerals and producing a first pregnant leach solution containing one or more of said one or more target metals and a residue ore material that contains at least a major portion of said refractory ore minerals;
treating the residue ore material in a second stage with a second leaching solution, said second leaching solution having a redox potential greater than about 0.80 V and being an aqueous, acidic, chloride leaching solution containing chlorate, and producing a second pregnant leach solution containing said one or more target metals; and
recovering the target metals from the first and second pregnant leach solutions.

13. The process according to claim 12, wherein the process further comprises:
providing a heap of the ore material;
treating the ore material with the first leaching solution; and
treating the residue ore material with the second leaching solution.

14. The process according to claim 12, wherein treating the ore material is performed at temperature below 75 °C.

15. The process according to claim 12, wherein the concentration of chlorate in the second leaching solution is between about 1 g/L ClO₃⁻ to about 25 g/L ClO₃⁻.

16. The process according to claim 12, wherein a chloride concentration of the second leaching solution is from about 90 g/L to about 140 g/L.

17. The process according to claim 12, wherein the second leaching solution further comprises one or more of iron, copper and/or an additional oxidant.

18. (canceled)

19. (canceled)

20. The process according to claim 12, comprising forming the second leaching solution in situ.

21. The process according to claim 12, wherein the target metal is a combination of copper, uranium and gold.

22. The process according to claim 12, wherein the refractory ore minerals comprise one or more of chalcocite, bornite and/or chalcopyrite.

23. A target metal recovered from an ore material using the process of claim 1.

24. A target metal recovered from an ore material using the process of claim 12.
